(19) United States
(12) Patent Application Publication
(10) Pub. No.: US 2013/0249466 A1
(43) Pub. Date: Sep. 26, 2013

(54) Photovoltaic System Having Burp Charger Performing Concept of Energy Treasuring and Recovery and Charging Method Thereof

(71) Applicants: Guan-Chyun Hsieh, Taoyuan County (TW); Hung-I Hsieh, Chiayi City (TW); Cheng-Yuan Tsai, Taipei City (TW); Chun-Kong Chan, New Taipei City (TW)

(72) Inventors: Guan-Chyun Hsieh, Taoyuan County (TW); Hung-I Hsieh, Chiayi City (TW); Cheng-Yuan Tsai, Taipei City (TW); Chun-Kong Chan, New Taipei City (TW)

(73) Assignees: Chung Yuan Christian University, Ta (TW); Lien Chang Electronic Enterprise Co., Ltd., Ne (TW)

(21) Appl. No.: 13/619,599

(22) Filed: Sep. 14, 2012

(30) Foreign Application Priority Data
Mar. 22, 2012 (TW) 101109926

(51) Int. Cl. H02J 7/00

(52) U.S. Cl. 320/101

(57) ABSTRACT

The Configurations of photovoltaic system and charging methods thereof are provided. The proposed photovoltaic system includes a first battery receiving a first pulse train to proceed a first charge during a first time period and engaging in an intense discharge to generate a second pulse train during a first portion of a second time period, a second battery receiving the first pulse train to proceed a second charge during the second time period, a third battery engaging in a third charge via the second pulse train during the first portion of the second time period, and a charge management controller controlling the first charge and the intense discharge of the first battery, the second charge of the second battery, and the third charge of the third battery.

### CROSS-REFERENCES TO RELATED APPLICATIONS

The application claims the benefit of Taiwan Patent Application No. 101109926, filed on Mar. 22, 2012, in the Taiwan Intellectual Property Office, the disclosures of which are incorporated herein in their entirety by reference.

### FIELD OF THE INVENTION

The present invention relates to a photovoltaic system comprising a first charger, a first, a second, and a third batteries, and a charge management controller. In particular, it relates to a photovoltaic burp charger performing concept of energy treasuring and recovery.

### BACKGROUND OF THE INVENTION

Recently, renewable energy has been significantly attractive to our life facing alternative energy sources to replace the fossil fuel. Except for the transferring from the renewable energy directly into such as grid to power utility, green house, and so on, the applications through indirect conversion are also the focus of attention, especially for such as stand-alone system, mobile solar charger, hybrid system etc. For suited equipment using renewable energy, solar and wind energies are advantaged in the mentioned indirect applications. However, the most important buffer for reliably sustaining the conversion between renewable energy and converter is nothing but battery, especially for lead-acid battery (LAB) that is still one of the most popular and widely-used batteries due to high reliability and low cost. Referring to the characteristic of LAB, when the charging of LAB approaches 85-95% of the state-of-charge (SOC), the majority of lead sulfate, PbSO₄ possibly leads the battery voltage to exceed the gassing voltage to cause the evolution of gaseous hydrogen at the negative electrode and oxygen at the positive electrode. This undesired phenomenon may produce heat, increasing the charging time, and shortening the life of the battery. Moreover, if LAB is in multiple discharges, some PbSO₄ may be crystallized on the positive electrode, reducing both the available surface area thereon and its electrochemical reactivity with battery acid, which is associated with the prolongation of battery life. Pulsed-current charging is an effective means of delaying the crystallization process in the active material and minimizing the development of the PbO layer during cycling. Burp charging uses a positive pulse to charge and uses a negative pulse to discharge so as to improve the charging time and prolong the life-cycle of the battery. But, how to give consideration to both the life-cycle of the battery and the concept of energy treasuring and recovery, for example the energy recovery during discharging, is a question deserving of consideration.

Keeping the drawbacks of the prior arts in mind, and employing experiments and research full-heartily and persistently, the applicant finally conceived a photovoltaic system having a burp charger performing concept of energy treasuring and recovery.

### SUMMARY OF THE INVENTION

It is a primary objective of the present invention to provide a photovoltaic burp charger and charging method thereof, the photovoltaic burp charger includes a charge management controller used to engage in a photovoltaic burp charge and two pulse charges in a main battery and two auxiliary batteries respectively so as to prolong the life-cycle of the battery and realizing the concept of energy treasuring and recovery.

According to the first aspect of the present invention, a photovoltaic system comprises a first charger generating a first pulse train, a first battery receiving the first pulse train at a first time period to engage in a first charge, and engaged in an intense discharge at an initial stage of a second time period so as to generate a second pulse train, a second battery receiving the first pulse train during the second time period to engage in a second charge, a third battery engaged in a third charge via the second pulse train during the initial stage, and a charge management controller controlling the first charge and the intense discharge of the first battery, the second charge of the second battery and the third charge of the third battery.

According to the second aspect of the present invention, a photovoltaic system comprises a first battery receiving a first pulse train at a first time period to engage in a first charge, and engaged in an intense discharge at an initial stage of a second time period so as to generate a second pulse train, and a second battery engaged in a second charge via the second pulse train during the initial stage of the second time period.

According to the third aspect of the present invention, a charging method for a photovoltaic system comprises steps of: providing a first pulse train; receiving the first pulse train at a first time period to engage in a first charge towards a first battery; and causing the first battery to engage in an intense discharge at an initial stage of a second time period to generate a second pulse train so as to engage in a second charge towards a second battery.

The present invention can be best understood through the following descriptions with reference to the accompanying drawings, in which:

### BRIEF DESCRIPTION OF THE DRAWINGS

FIG. 1(a) shows a circuit diagram of a photovoltaic system having photovoltaic burp chargers according to the preferred embodiment of the present invention;

FIG. 1(b) shows a waveform diagram of a typical burp pulse;

FIG. 2(a) shows a circuit diagram of a photovoltaic system having photovoltaic burp chargers and guided by a incremental-conductance (INC) MPPT controller according to the preferred embodiment of the present invention;

FIG. 2(b) shows a circuit diagram of a gassing voltage monitor in the prior art;

FIG. 2(c) shows a waveform diagram of all the driving signals of the circuit as shown in FIG. 2(a);

FIG. 3(a) shows a dynamic state diagram of a photovoltaic system having photovoltaic burp chargers when BPP charges to the battery B1 during a time period of tp1, and B2 and B3 are at rest;

FIG. 3(b) shows a dynamic state diagram of a photovoltaic system having photovoltaic burp chargers when the positive pulse (PP) charges to the battery B2 during a time period of tp2, and temporarily stops during a time period of td, and B1 engages in an intense charge to B3 during a time period of tp3, which equals to a BNP charge;

FIG. 3(c) shows a dynamic state diagram of a photovoltaic system having photovoltaic burp chargers when B1 and B3 are at rest during a time period of td, wherein B2 engages in the PP charge from t2 to t3, then to tp2 and until the end of a charging period of Ts2;

FIG. 4(a) shows a circuit diagram of the equivalent half-circuit of IFC-1;

FIG. 4(b) shows a waveform diagram of V_{Fgs1}/V_{Fgs2}, the primary current i_{pI,2} and the secondary current i_{sI,2};

FIG. 4(c) shows a circuit diagram of an equivalent circuit of a model of control to output (PV array to charging current) under maximum power transfer;

FIGS. 5(a)-5(b) respectively shows simulation and experiment (from design example) results for the control-to-output model as shown in FIG. 4(c), in which the output current and output power versus switching frequency fₛ₁ are measured for various solar insolations;

FIG. 6 shows a waveform diagram for predicting dynamic state of a photovoltaic system having photovoltaic burp chargers according to the preferred embodiment of the present invention;

FIG. 7(a) shows a circuit diagram of an equivalent circuit of a typical solar cell unit;

FIG. 7(b) shows a waveform diagram presenting Iₚᵥ-Vₚᵥ and Pₚᵥ-Vₚᵥ characteristic curves of the PV array at T=25° C. (solid line) and 55° C. (dotted line) for various solar insolations;

FIG. 8 shows a control chart of an INC MPPT controller of a photovoltaic system having photovoltaic burp chargers according to the preferred embodiment of the present invention;

FIG. 9(a) shows a flow chart of a main program of an INC MPPT controller of a photovoltaic system having photovoltaic burp chargers according to the preferred embodiment of the present invention;

FIG. 9(b) shows a flow chart of a subroutine of an INC MPPT controller of a photovoltaic system having photovoltaic burp chargers according to the preferred embodiment of the present invention;

FIG. 10(a) shows a waveform diagram of the gate source voltages V_{Fgs1} and V_{Fgs2}, and the primary side currents iₚ₁ and iₚ₂ of the first interleaved flyback converter IFC-1 according to the preferred embodiment of the present invention;

FIG. 10(b) shows a waveform diagram of the gate source voltage V_{Fgs1} and V_{Fgs2}, and the secondary side currents iₛ₁ and iₛ₂ of the first interleaved flyback converter IFC-1 according to the preferred embodiment of the present invention;

FIG. 11(a) shows measured gate drive signals V_{Tgs1} and V_{Tgs2} for Q_{T1}, Q_{T2}, at a low frequency of 550 Hz, and V_{Fgs1}, V_{Fgs2} and V_{Fgs3} for Q_{F1}, Q_{F2}, and Q_{F3} at a high frequency of 19 kHz according to the preferred embodiment of the present invention;

FIG. 11(b) shows the measured gate drive signals V_{Tgs1} and V_{Tgs2} for Q_{T1} and Q_{T2}, the charge current i_{B1} for B1 and the charge current i_{B2} for B2 according to the preferred embodiment of the present invention;

FIG. 11(c) shows the measured gate drive signals V_{Tgs1} and V_{Tgs2} for Q_{T1} and Q_{T2}, and the burp charging currents i_{B1} and iₚ₃ according to the preferred embodiment of the present invention;

FIG. 12(a) shows trajectories of the proposed PV burp charger presenting the state-of-charge (SOC) of the three batteries in the process of PV burp charge, in which the charging process excluding the burp charge to B1 also contributes pulse charges to B2 and B3 in the non-burp charge period; and

FIG. 12(b) compares the charging and temperature trajectories of the proposed PV burp charger with those obtained using the CC/CV charging strategy, at an average charging rate of 0.2 C, where 1 C=45 AH, under solar insolation of 1 kW/m².

### DETAILED DESCRIPTION OF THE PREFERRED EMBODIMENT

Although the following description contains many specifications for the purposes of illustration, anyone of ordinary skill in the art will appreciate that many variations and alterations to the following details are within the scope of the invention. Accordingly, the following preferred embodiment of the invention is set forth without any loss of generality to and without imposing limitations upon, the claimed invention.

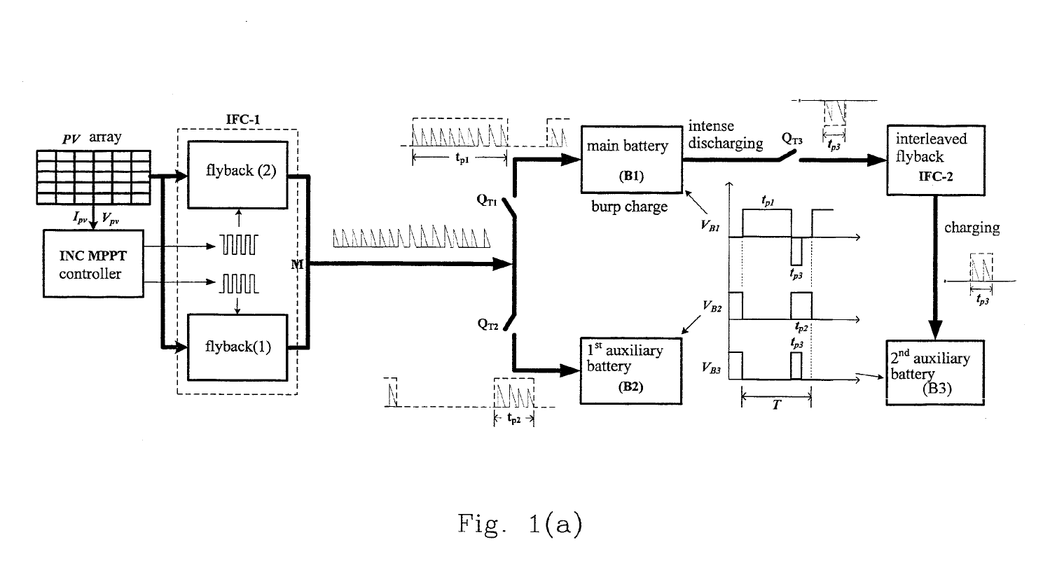

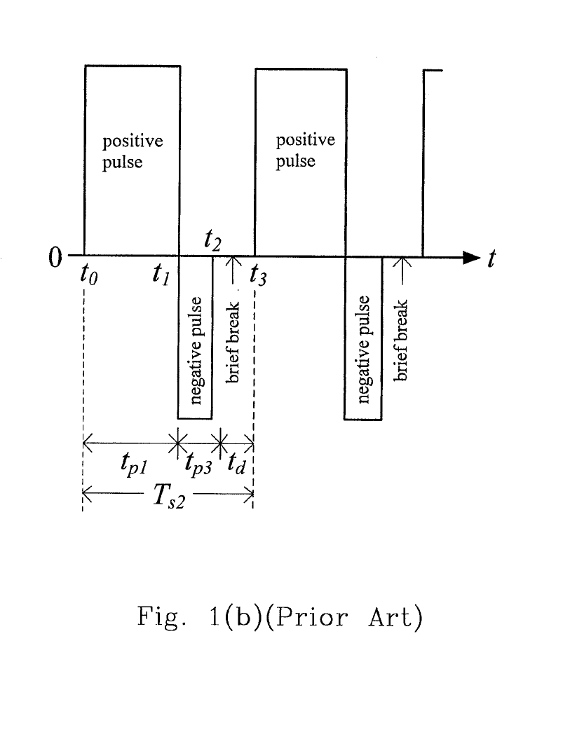

FIG. 1(a) shows a circuit diagram of a photovoltaic system having photovoltaic burp chargers according to the preferred embodiment of the present invention. In FIG. 1(a), the photovoltaic system having the photovoltaic burp charger includes a PV array, an interleaved flyback converter IFC-1 (a first charger), a main battery (a first battery) B1, a first auxiliary battery (a second battery) B2, a second auxiliary battery (a third battery) B3, an interleaved flyback converter IFC-2 (a second charger), and three transmission switches Q_{T1}, Q_{T2} and Q_{T3}, wherein the IFC-1 includes two flyback converters connected to each other in parallel, flyback (1) and flyback (2), and outputs an interleaved high-frequency tiny pulse train (a first pulse train). The first battery B1 receives the first pulse train at a first time period (tp1) to engage in a first charge (burp charge), and B1 engages in an intense discharge at an initial stage (tp3) of a second time period so as to generate a second pulse train, the second battery B2 receives the first pulse train during the second time period (tp2) to engage in a second charge, the third battery B3 engages in a third charge via the second pulse train during the initial stage (tp3).

FIG. 1(b) shows a waveform diagram of a typical burp pulse. In a charge period Tₛ₂ of FIG. 1(b), a positive pulse (BPP) is shown located in the first time period (tp1), a negative pulse (BNP) is shown located in the initial stage (tp3) of the second time period, and then there is a brief break time period T_{d}.

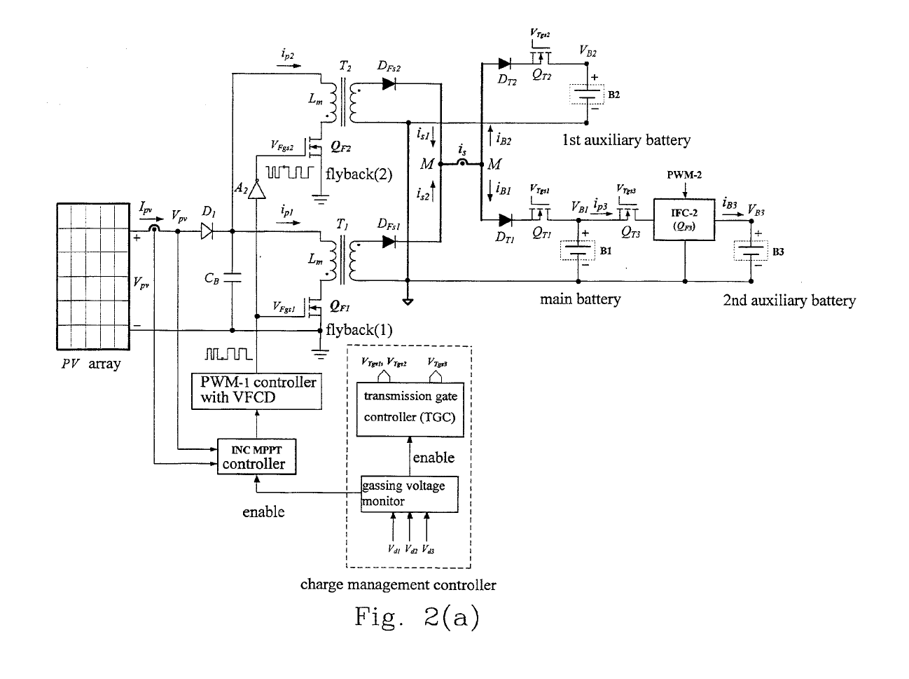

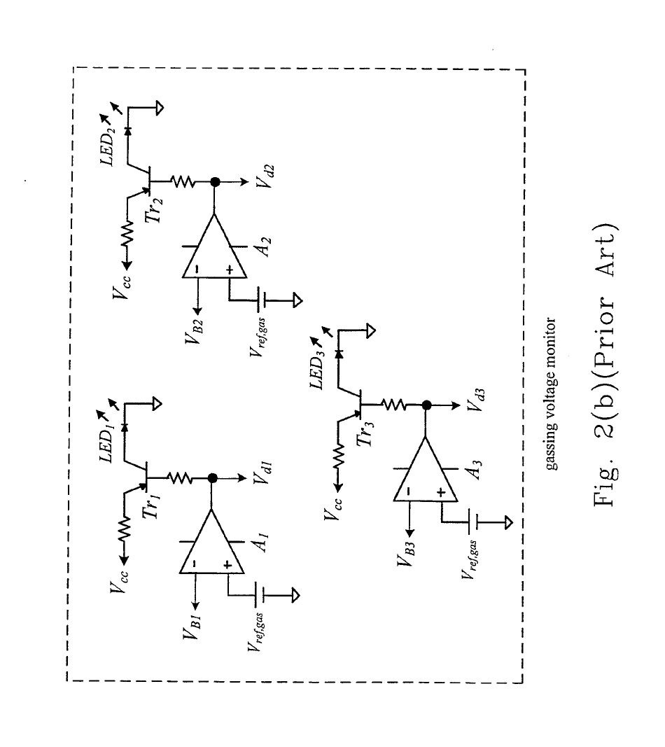

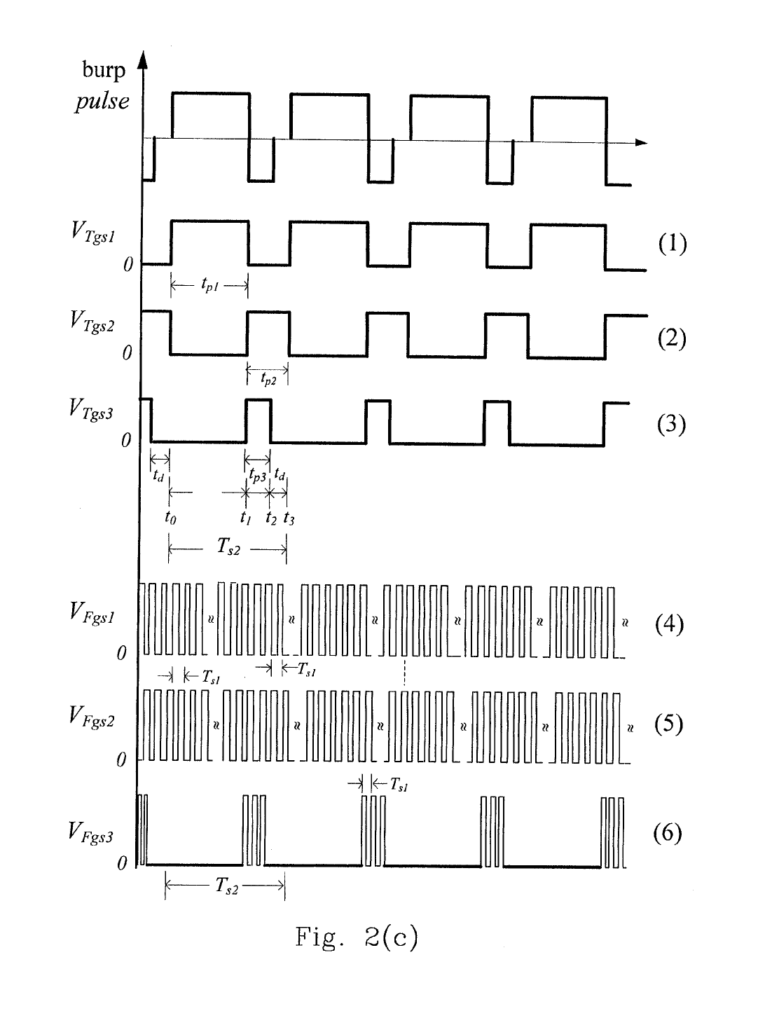

FIG. 2(a) shows a circuit diagram of a photovoltaic system having photovoltaic burp chargers and guided by an incremental-conductance (INC) MPPT controller according to the preferred embodiment of the present invention. In FIG. 2(a), except for those elements included in FIG. 1(a), the photovoltaic system further includes a PWM-1 controller having variable frequency and constant duty (VFCD) and a charge management controller (CMC), and the second charger IFC-2 includes a switch Q_{F3}, wherein the second charger IFC-2 is electrically connected between the third battery B3 and the third transmission switch Q_{T3}, is used to receive the second pulse train and generates a charging pulse train charging the third battery B3, the first transmission switch Q_{T1} is electrically connected between the first charger IFC-1 and the first battery B1, the second transmission switch Q_{T2} is electrically connected between the first charger IFC-1 and the second battery B2, the third transmission switch Q_{T3} is electrically connected to the first battery B1, and the CMC generates a first, a second, and a third control signals V_{Tgs1}, V_{Tgs2} and V_{Tgs3} controlling a turn-on and a turn-off of the first to the third transmission switches Q_{T1}, Q_{T2} and Q_{T3} respectively, and controlling when the first battery B1 engages in the first charge and the intense discharge, when the second battery B2 engages in the second charge, and when the third battery B3 engages in the third charge. The first battery B1, the second battery B2 and the third battery B3 generate a first, a second and a third gassing voltage detection values, Vd1, Vd2 and Vd3 respectively. The first, the second and the third transmission switches Q_{T1}, Q_{T2} and Q_{T3} include respective gates. The charge management controller includes a transmission gate controller (TGC) and a gassing voltage monitor, the transmission gate controller outputs the first, the second and the third control signals V_{Tgs1}, V_{Tgs2} and V_{Tgs3} to the respective gates to control the turn-on and the turn-off of the first, the second and the third transmission switches Q_{T1}, Q_{T2} and Q_{T3}. The gassing voltage monitor receives the first, the second and the third gassing voltage detection values Vd1, Vd2 and Vd3 and outputs respective enable signals to the transmission gate controller and the INC MPPT controller. The transmission gate controller engages in a normal operation and the INC MPPT controller engages in an MPPT when all the first, the second and the third gassing voltage detection values Vd1, Vd2 and Vd3 are not reaching a gassing voltage value, and the transmission gate controller ceases the normal operation and the INC MPPT controller ceases the MPPT when at least one of the first, the second and the third gassing voltage detection values Vd1, Vd2 and Vd3 reaches the gassing voltage value, where a gassing battery should be replaced at this moment. The photovoltaic system further comprises diodes D1, DT1 and DT2, and a capacitor C_{B}. The PWM-1 controller receives a control signal from the INC MPPT controller, and outputs a pulse-width modulation (PWM) signal to an inverter A2 of the IFC-1. Each of the two flyback converters, flyback (1) and flyback (2), includes a switch Q_{F1}/Q_{F2}, a transformer T₁/T₂, an inductor Lₘ/Lₘ and a diode D_{Fs1}/D_{Fs2}.

FIG. 2(b) shows a circuit diagram of a gassing voltage monitor in the prior art. The gassing voltage monitor includes three sub-circuits, each of which includes an operational amplifier (A1/A2/A3), a transistor (Tr1/Tr2/Tr3), an LED (LED1/LED2/LED3) and two resistors. The first, the second and the third gassing voltage detection values Vd1, Vd2 and Vd3 are respectively inputted to a terminal of each of the three sub-circuits. Once anyone of the batteries is reaching the gassing voltage, the monitor will turn on the LED to indicate the gassing battery, the charge management controller CMC will disable all functions of the IFC-1 and the transmission switches at this moment, and this is the time to replace the gassing battery.

FIG. 2(c) shows a waveform diagram of all the driving signals of the circuit as shown in FIG. 2(a). The driving signals include V_{Tgs1}, V_{Tgs2} and V_{Tgs3} applied to respective gates of Q_{T1}, Q_{T2} and Q_{T3} and V_{Fgs1}, V_{Fgs2} and V_{Fgs3} applied to respective gates of Q_{F1}, Q_{F2} and Q_{F3}.

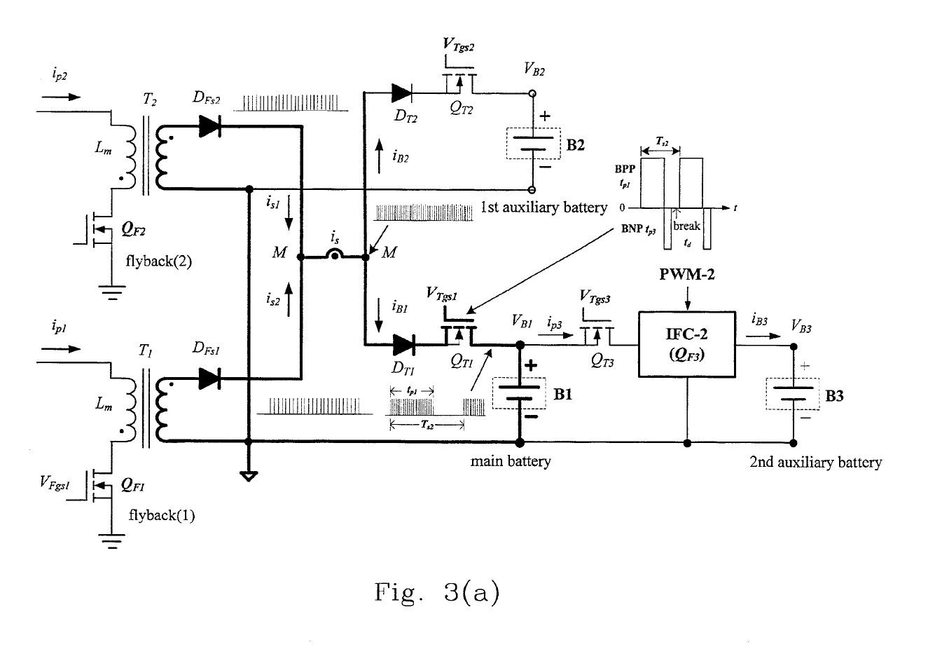

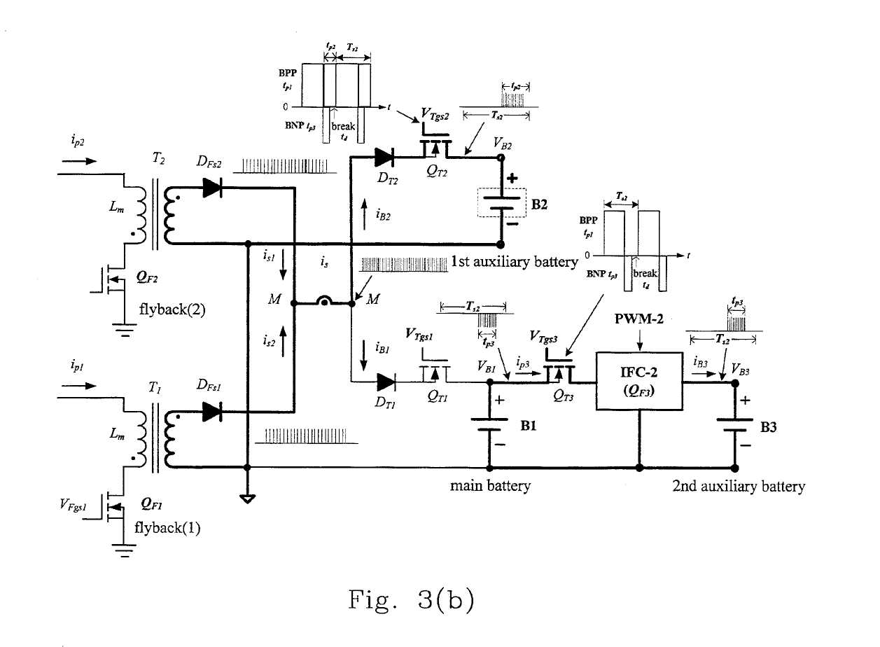

FIG. 3(a) shows a dynamic state diagram of a photovoltaic system having photovoltaic burp chargers, it is when BPP charges to the battery B1 during a time period of tp1, and B2 and B3 are at rest.

FIG. 3(b) shows a dynamic state diagram of a photovoltaic system having photovoltaic burp chargers, it is when the positive pulse (PP) charges to the battery B2 during a time period of tp2, and is temporarily stopped during a time period of td, and B1 engages in an intense charge to B3 during a time period of tp3, which equals to a BNP charge.

FIG. 3(c) shows a dynamic state diagram of a photovoltaic system having photovoltaic burp chargers, it is when B1 and B3 are at rest during a time period of td, wherein B2 engages in the PP charge from t2 to t3, then to tp2 and until the end of a charging period of Ts2 (see FIG. 2(c)).

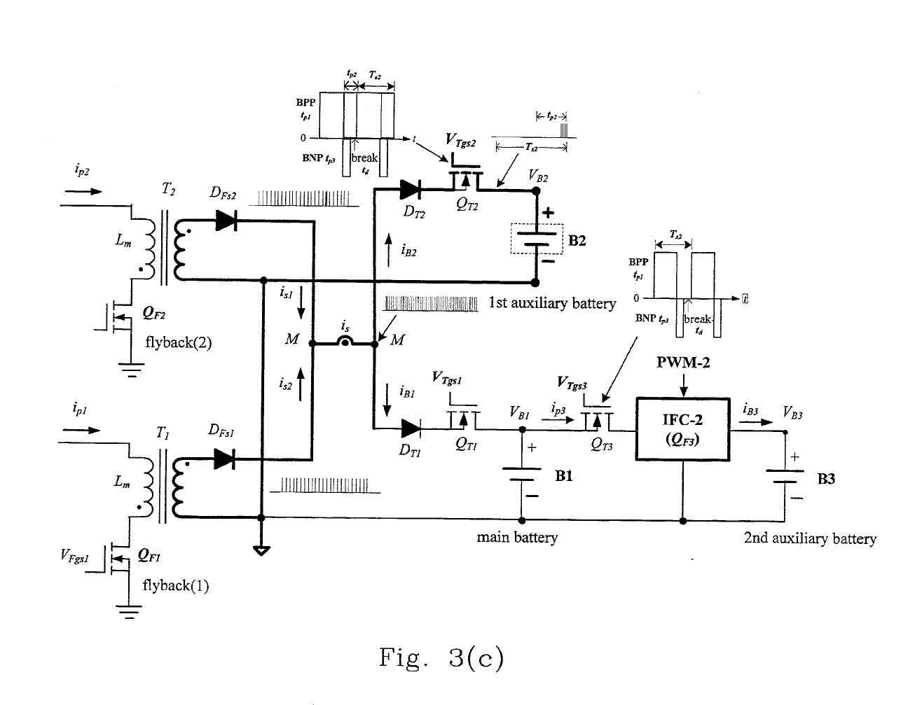

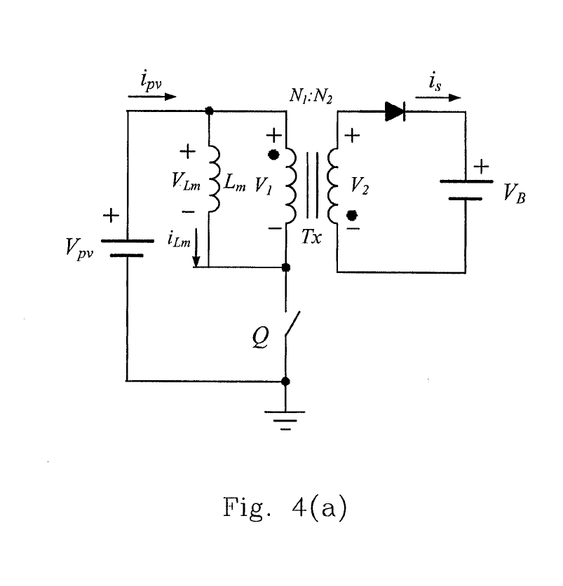

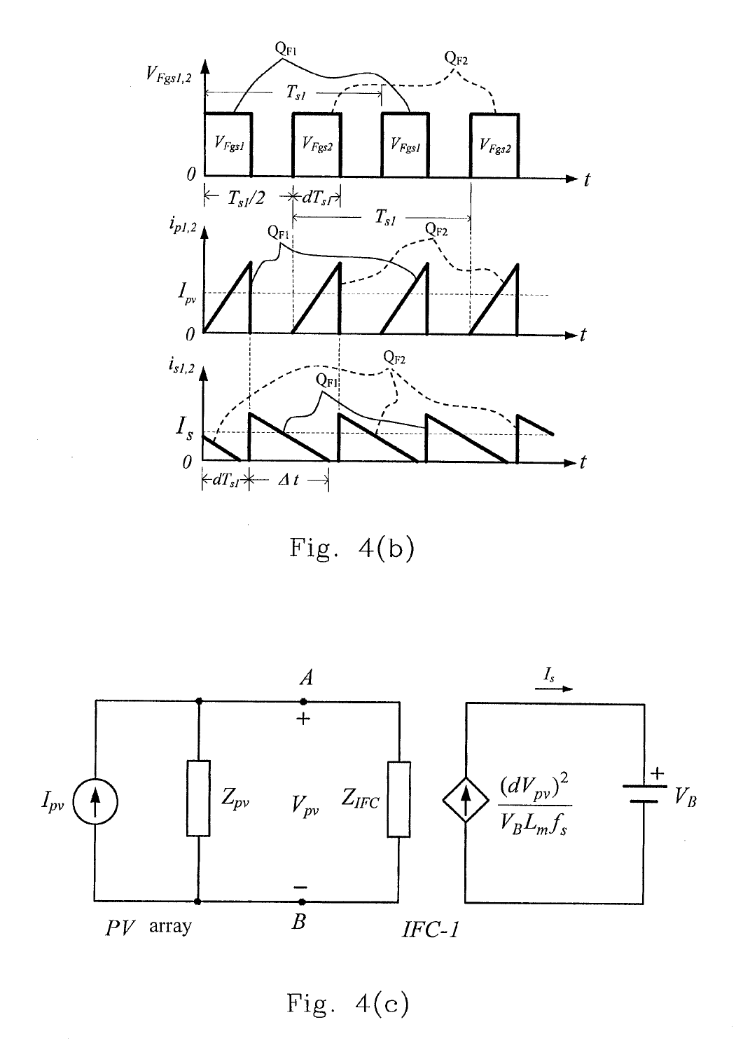

FIG. 4(a) shows a circuit diagram of the equivalent half-circuit of IFC-1, in which the inner resistance r_{Lm} of the transformer is neglected and all parameters of the two flyback converters are presumed the same to facilitate analysis. FIG. 4(b) predicts the primary current i_{pI,2} drawn from the PV array and the secondary current i_{sI,2} that charges the battery. The peak current îₚ₁=îₚᵥ₁ of the PV array through a single flyback converter of IFC-1 can be given by

$${\hat{i}}_{pv 1} = \frac{{V}_{pv}}{{L}_{m}} {t}_{on} \qquad ( 1 )$$

The average current Iₚᵥ₁ in the drawing period Tₛ₁ is obtained as

$${I}_{pv 1} = \frac{{V}_{pv} {d}^{2}}{2 {L}_{m} {f}_{s 1}} \qquad ( 2 )$$

where d is duty cycle, Lₘ is magnetizing inductance, and fₛ₁ is switching frequency. If the characteristics of the two flyback converters of IFC-1 are presumed the same, Iₚᵥ₁ and Iₚᵥ₂ from PV array are equal and the total average PV current Iₚᵥ from (2) will be,

$$\begin{matrix}{I}_{pv} = \frac{{V}_{pv} {d}^{2}}{{L}_{m} {f}_{s 1}} & ( 3 ) \\ η {I}_{pv} {V}_{pv} = {I}_{s} {V}_{B} & ( 4 )\end{matrix}$$

Where Vₒ=V_{B}, Pₒ=IₛV_{B} and Pₚᵥ=IₚᵥVₚᵥ. The output current Iₛ and power Pₒ can then be obtained from (3) and (4) as

$$\begin{matrix}{I}_{s} = \frac{{η ( {V}_{pv} d )}^{2}}{{V}_{B} {L}_{m} {f}_{s 1 }} \\ and & ( 5 ) \\ {P}_{o} = \frac{{η ( {V}_{pv} d )}^{2}}{{L}_{m} {f}_{s 1 }} & ( 6 )\end{matrix}$$

From Eq. (5), the control-to-output transfer function between IFC-1 and PV array can be represented by

$$\frac{{I}_{s}}{{f}_{s 1}^{- 1}} = \frac{{η ( {V}_{pv } d )}^{2}}{{V}_{B} {L}_{m }} \qquad ( 7 )$$

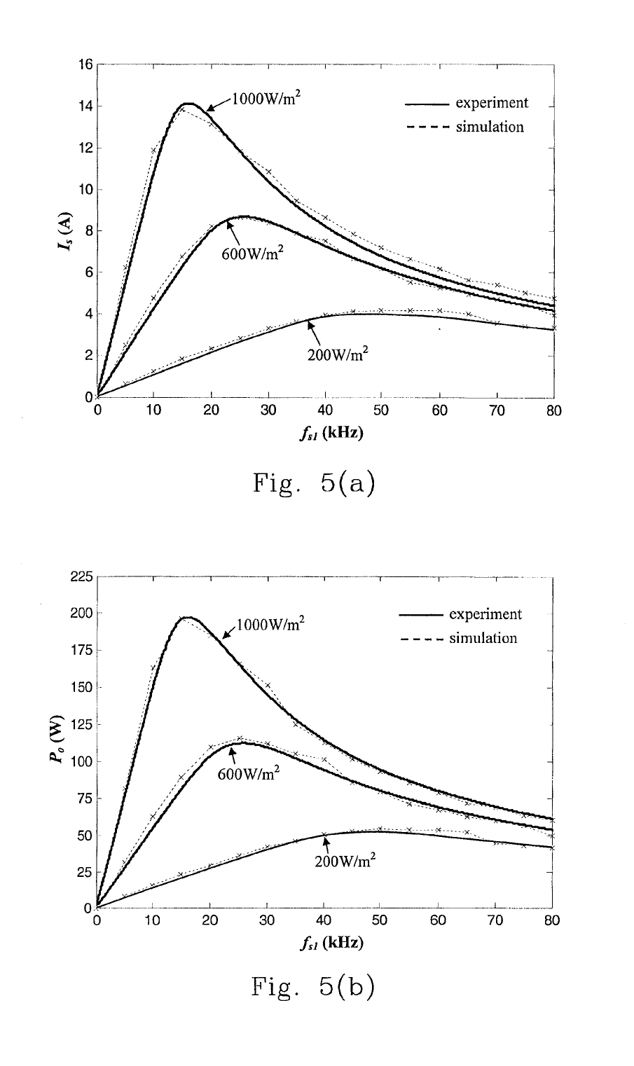

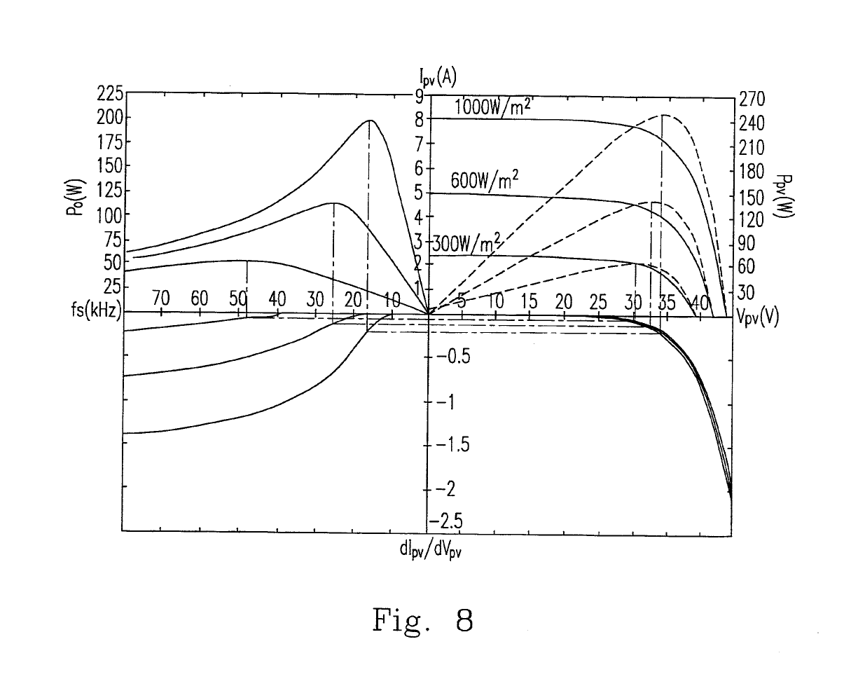

The circuit model of the control-to-output (from the PV array to the charging current) is shown in FIG. 4(c), in which the output current Iₛ is inversely proportional to the control frequency fₛ₁, which is also designed to suit the tracking chart of FIG. 8. The simulation and experiment (from design example) for the control-to-output model are shown in FIGS. 5(a)-(b), in which the output current and output power versus switching frequency fₛ₁ are measured for various solar insolations. However, the impedance of the PV array is inherently capacitive, because of the diffusion and transition capacitances at high frequency. For attaining maximum Iₛ, the conjugate impedance of the PV array should be equal to the inductive impedance of the IFC-1, i.e.,

$$\begin{matrix}{Z}_{IFC} = {\overline{Z}}_{pv} \\ Where & ( 8 ) \\ {Z}_{IFC} = j 2 π {f}_{s 1} {L}_{m} \\ And & ( 9 ) \\ {Z}_{pv} = \frac{1}{j 2 π {f}_{s 2} {C}_{pv}} & ( 10 )\end{matrix}$$

Since the PV array and the IFC-1 are frequency-dependent, the INC MPPT using frequency control is feasible for guiding the IFC-1 in energy pump. If the internal resistances between the PV array and the IFC-1 are neglected for analysis, the LₘCₚᵥ relative to the switching frequency fₛ₁ at maximum power transfer can then be represented by

$${L}_{m} {C}_{pv} = {( \frac{1}{2 π {f}_{s 1}} )}^{2} \qquad ( 11 )$$

The period Tₛ₂ of the transmission gates Q_{T1} and Q_{T2} can be estimated as

$$\begin{matrix}{T}_{s 2} = {t}_{p 1} + {t}_{d 1} \\ = {d}_{d 2} + {t}_{p 2} \\ = ( {m}_{1} + {m}_{2} ) {T}_{s 1} \\ = {t}_{d 31} + {t}_{d 32} + {t}_{p 3}\end{matrix} \qquad ( 12 )$$

Where

tₚ₁=m₁Tₛ₁, t_{d1}=m₂Tₛ₁, tₚ₁=t_{d2}, tₚ₂=t_{d1}, and tₚ₃=m₃Tₛ₃.

For ease of analysis and synthesis of the charging currents, the instantaneous current iₚ₁ and iₚ₂ from PV array are redefined as

$$\begin{matrix}{i}_{p 1} = \{ \begin{matrix}\frac{{V}_{pv}}{{L}_{m}} t & 0 < t < {dT}_{s 1} \\ 0 & {dT}_{s 1} < t < {T}_{s 1}\end{matrix} \\ and & ( 13 ) \\ {i}_{p 2} = \{ \begin{matrix}\frac{{V}_{pv}}{{L}_{m}} ( t - \frac{{T}_{s 1}}{2} ) & \frac{{T}_{s 1}}{2} < t < ( \frac{{T}_{s 1}}{2} + {dT}_{s 1} ) \\ 0 & Otherwise\end{matrix} & ( 14 )\end{matrix}$$

The two average currents iₛ₁ and iₛ₂ from IFC-1 before synthesis can be given by, from (5),

$${I}_{s 1} = {I}_{s 2} = \frac{{η ( {V}_{pv} d )}^{2}}{2 {V}_{B} {L}_{m} {f}_{s 1}} \qquad ( 15 )$$

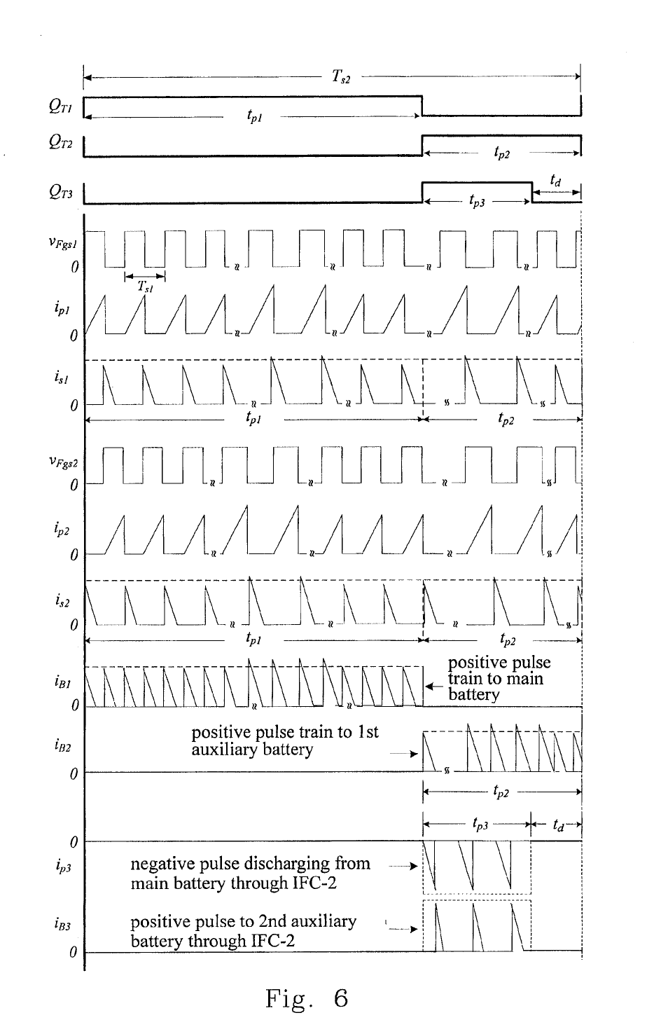

The windowed pulse train current i_{B1} for B1 flows when Q_{T1} turns on in the interval tₚ₁=m₁Tₛ₁. FIG. 6 shows a waveform diagram for predicting dynamic state of a photovoltaic system having photovoltaic burp chargers according to the preferred embodiment of the present invention. The average i_{B1} in the low-frequency charging period, Tₛ₂, as displayed in FIG. 6, can be represented by

$${I}_{B 1} = \frac{{m}_{1}}{{m}_{1} + {m}_{2}} \cdot \frac{{η ( {V}_{pv} d )}^{2}}{{V}_{B 1} {L}_{m} {f}_{s 1 }} \qquad ( 16 )$$

When Q_{T2}, complementary to Q_{T1}, turns on in the interval tₚ₂=m₂Tₛ₁, the average current i_{B2} that charges B2 is obtained as,

$${I}_{B 2} = \frac{{m}_{2}}{{m}_{1} + {m}_{2}} \cdot \frac{{η ( {V}_{pv} d )}^{2}}{{V}_{B 2} {L}_{m} {f}_{s 1 }} \qquad ( 17 )$$

Then, the average intense discharging current i_{B1,d} from the B1 through IFC-2 in the interval tₚ₃=m₃Tₛ₁, equivalent to the average charging current of the B3, is given by

$${I}_{B 1 , d} = \frac{{V}_{B 1} {d}^{2}}{{L}_{m} {f}_{s 1}} \qquad ( 18 )$$

where the peak discharging current from B1 is given by

$${\hat{i}}_{B 1 , d} = \frac{{V}_{B 1}}{{L}_{m}} {dT}_{s 1} \qquad ( 19 )$$

For ease of analysis, all parameters of IFC-2 are presumed to be identical to those of IFC-1; the dynamic states of IFC-2 are the same as those in FIG. 4(b). From Eq. (18), the average discharging current Iₚ₃ is

$${I}_{p 3} = \frac{{m}_{3}}{{m}_{1} + {m}_{2}} \cdot \frac{{V}_{B 1} {d}^{2}}{{L}_{m} {f}_{s 1}} \qquad ( 20 )$$

Accordingly, the average current Iₛ₃ that charges the B3 through IFC-2 in each charging period Tₛ is then given by

$${I}_{s 3} = \frac{{η ( {V}_{B 1} d )}^{2}}{{V}_{B 3} {L}_{m} {f}_{s 1}} \qquad ( 21 )$$

and the average charging current that charges the B3 is to be

$${I}_{B 3} = \frac{{m}_{3}}{{m}_{1} + {m}_{2}} \cdot \frac{{η ( {V}_{B 1} d )}^{2}}{{V}_{B 3} {L}_{m} {f}_{s 1 }} \qquad ( 22 )$$

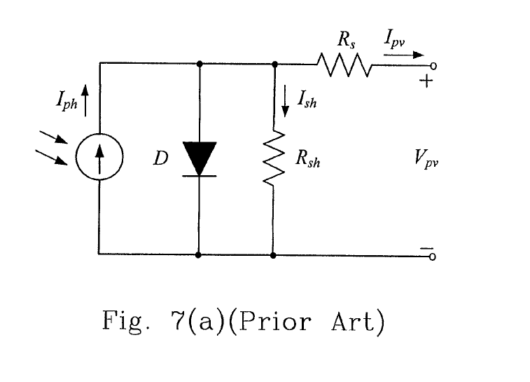

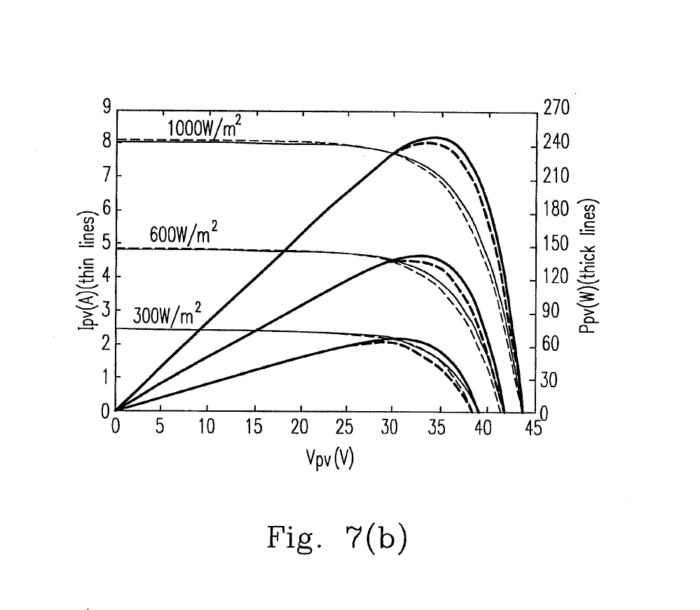

FIG. 7(a) shows a circuit diagram of an equivalent circuit of a typical solar cell unit, wherein D is an LED, Rsh is a parallel-connected inner resistor, Rs is a series-connected inner resistor, and Iph is an output current of the solar cell unit.

Via a principle that a rate of change of an output power with respect to a voltage of a solar panel is zero at an MPPT, and at a place corresponding to dP/dV=0 on the current-voltage characteristic curve, e.g. as shown in FIG. 7(b), the incremental conductance method directly finds out

$$\frac{Δ I}{Δ V} = - \frac{I}{V} , \qquad ( 23 )$$

where I is a solar cell current, V is a solar cell voltage, ΔV is a voltage increment, and ΔI is a current increment. Via measuring a conductance value of ΔI/ΔV and compared it with an instantaneous conductance of −I/V of the solar panel to judge whether ΔI/ΔV is larger than, smaller than, or equivalent to −I/V so as to determine whether the next incremental change should be continued. When the incremental conductance conforms to formula (23), the solar panel is for sure to be operated at a maximum power point (MPP), and there will be no more next increment. This method engages in a tracking via the modification of the logic expression, there is not any oscillation around the MPP such that it is more suitable to the constantly changing conditions of the atmosphere. The incremental conductance method can accomplish the MPPT more accurately and decrease the oscillation problem as in the perturbation and observation method.

According to FIG. 7(a), the current-voltage characteristic of the solar cell unit can be indicated as

$$\begin{matrix}{I}_{pv} = {I}_{p h} - {I}_{pvo} \{ exp [ \frac{q}{AkT} ( {V}_{pv} + {I}_{pv} {R}_{s} ) ] - 1 \} \\ and & ( 24 ) \\ {V}_{pv} = \frac{AkT}{q} ln ( \frac{{I}_{p h} - {I}_{pv} + {I}_{pvo}}{{I}_{pvo }} ) - {I}_{pv} {R}_{s} & ( 25 )\end{matrix}$$

where Iₚₕ denotes light-generated current; Iₚᵥₒ is dark saturation current; Iₚᵥ is PV electric current; Vₚᵥ is PV voltage; Rₛ is series resistance; A is the non-ideality factor; k is Boltzmann's constant; T is temperature, and q is the electronic charge. The output power from the PV cell can then be given by

$$\begin{matrix}{P}_{pv} = {V}_{pv} {I}_{pv} \\ = {I}_{pv} \{ \frac{AkT}{q} ln ( \frac{{I}_{p h} - {I}_{pv} + {I}_{pvo}}{{I}_{pvo}} ) - {I}_{pv} {R}_{s} \}\end{matrix} \qquad ( 26 )$$

The PV array operating at MPP is when

$$\begin{matrix}\frac{d {P}_{pv}}{d {V}_{pv}} = 0 \\ or & ( 27 ) \\ \begin{matrix}\frac{d {P}_{pv}}{d {V}_{pv}} = {V}_{pv} \frac{d {I}_{pv}}{d {V}_{pv}} + {I}_{pv} \\ = 0\end{matrix} & ( 28 )\end{matrix}$$

As for the INC MPPT, the criterion can then be given by, from (28),

$$\frac{d {I}_{pv}}{d {V}_{pv}} = - \frac{{I}_{pv}}{{V}_{pv} } \qquad ( 29 )$$

In reality, an alternative expression to replace the derivative in (29) is frequently used for ease of calculation in the algorithm, i.e.

$$\frac{Δ {I}_{pv}}{Δ {V}_{pv}} \approx \frac{d {I}_{pv}}{d {V}_{pv}} = - \frac{{I}_{pv}}{{V}_{pv}} \qquad ( 30 )$$

Design Considerations

1. Charge Management

As presented in FIG. 1(b), two complementary transmission gates Q_{T1} and Q_{T2} involved in charging the B1 and B2 are for energy-treasuring. A third transmission gate Q_{T3} introduced to intensely discharge the B1 through IFC-2 to charge B3, equivalent to BNP charging, is for energy recovery. In this design of the present invention, the BPP charge to B1 via Q_{T1} is programmed using such that 80% of the burp period; 10% is associated with a BNP for intensely discharging B1 to B3 via Q_{T3}, and 10% is the relaxation period. B2 accepts a windowed PP for charging during 20% of the burp period via Q_{T2} excluding the 80% for Q_{T1}, which ensures the continuity of INC MPPT and increases the utilization of the PV array. Three gassing voltage detections are always on-line monitoring the instant charging behaviors of the batteries (KAWASAKI NF50B24LS 45-AH battery) with a gassing reference of 13.8V.

2. Interleaved IFC

IFC-1 is designed according to the tracking of INC MPPT with VFCD control and IFC-2 for B1 executing BNP discharging to B3 can be either single or interleaved flyback converter using constant-frequency control. Moreover, the two IFCs are designed to operate in discontinuous-conduction mode (DCM) to avoid overlap between adjacent tiny pulses, to reduce the sulfating crystallization on the positive electrode of LAB.

3. Algorithm of INC MPPT

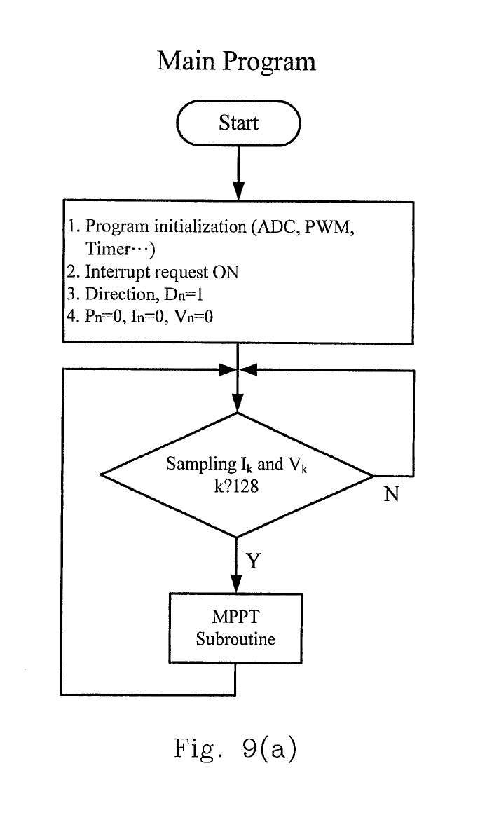

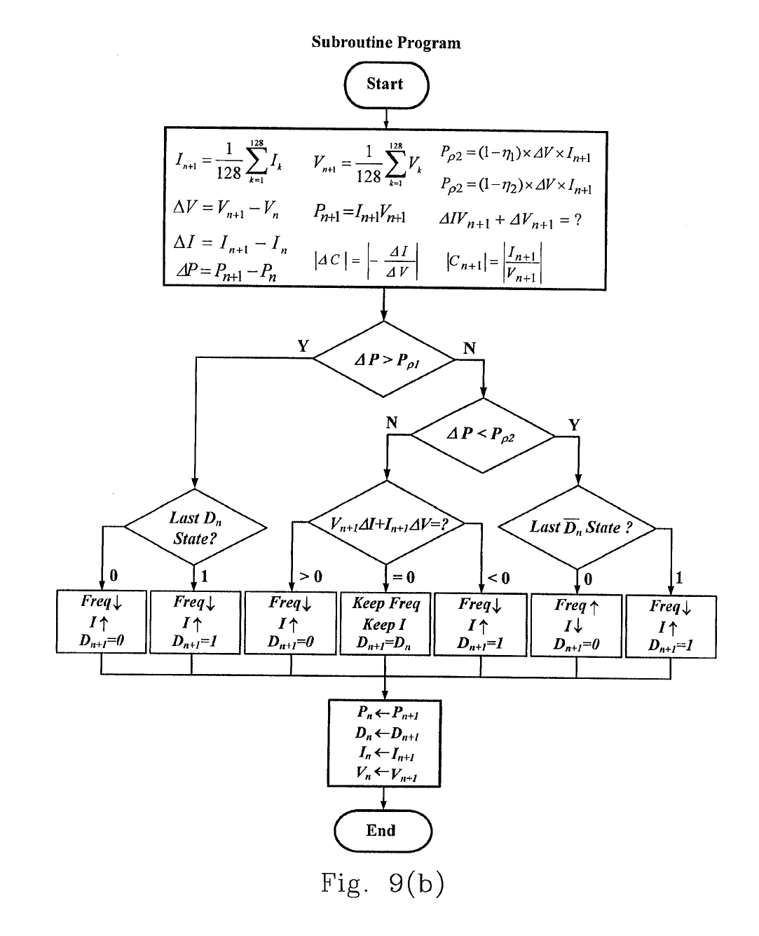

The algorithm of INC MPPT is executed by Microchip dsPIC33FJ06GS202 according to the flowchart in FIG. 9. The tracking chart in FIG. 8 is the primary reference for the algorithm.

### Design and Experiment

An experimental setup of a PV burp charger system is established with the circuit structure in FIG. 2(a), which equips with a 260-W two-PV-in-series module and three 45-AH LABs of KAWASAKI NF50B24LS. The charger provides maximum peak current of 24 A for the tiny pulse train @ 1 kW/m² and a 38-A peak current for the intense-discharge pulse, where the IFC-1 and IFC-2 with a duty ratio of 0.26 operate at 14.6 kHz, and the transmission gates Q_{T1}, Q_{T2}, and Q_{T3} operate as suggested 550 Hz. The interval of BPP, tₚ₁, for the B1 is designed to be 80% of Tₛ₂(=1/fₛ₂) and that of PP, tₚ₂, for B2 is 20% of Tₛ₂. For the BNP equivalent to intense discharge from the B1 is 10% of Tₛ₂. Each PV module of Kyocera KC130T has an open voltage of 21.9V and a short current of 8.2 A @ 1 kW/m². FIG. 7(b) presents Iₚᵥ-Vₚᵥ and Pₚᵥ-Vₚᵥ characteristic curves of the PV array at T=25° C. (solid line) and 55° C. (dotted line) for various solar insolations.

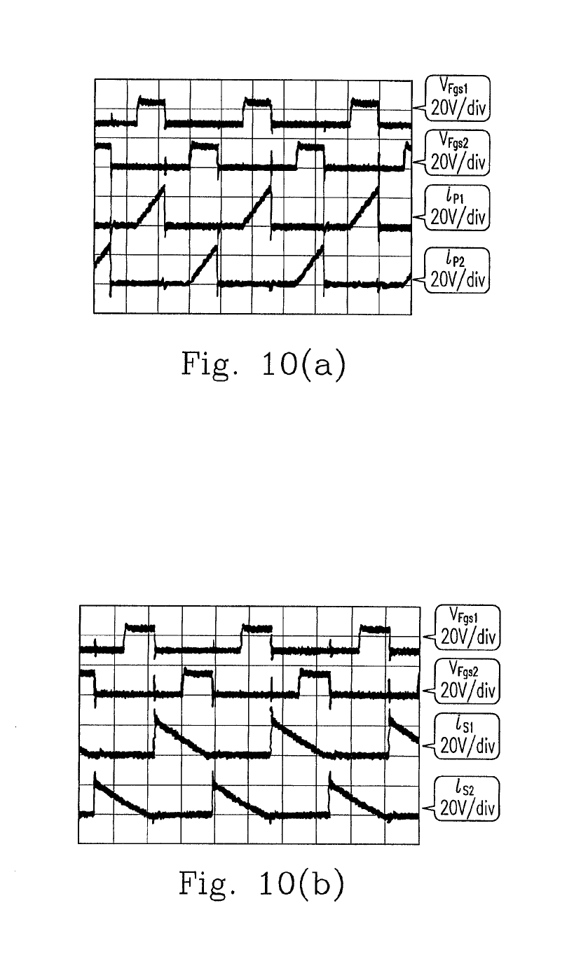

FIG. 10(a) shows a waveform diagram of the gate source voltages V_{Fgs1} and V_{Fgs2} and the primary side currents iₚ₁ and iₚ₂ of the first interleaved flyback converter IFC-1 according to the preferred embodiment of the present invention. FIG. 10(b) shows a waveform diagram of the gate source voltage V_{Fgs1} and V_{Fgs2}, and the secondary side currents iₛ₁ and iₛ₂ of the first interleaved flyback converter IFC-1 according to the preferred embodiment of the present invention.

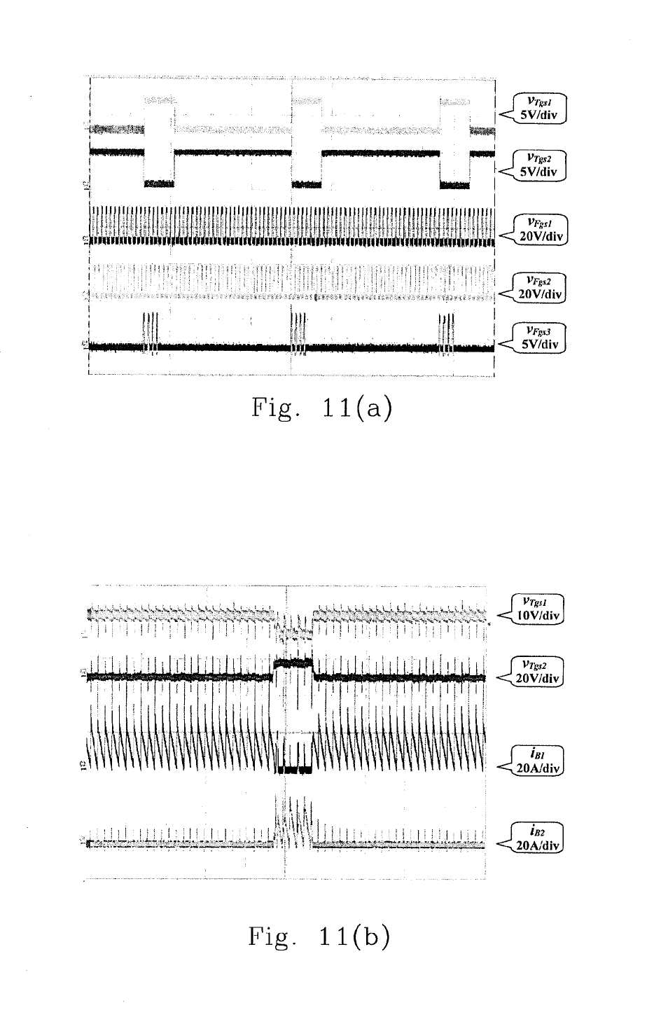

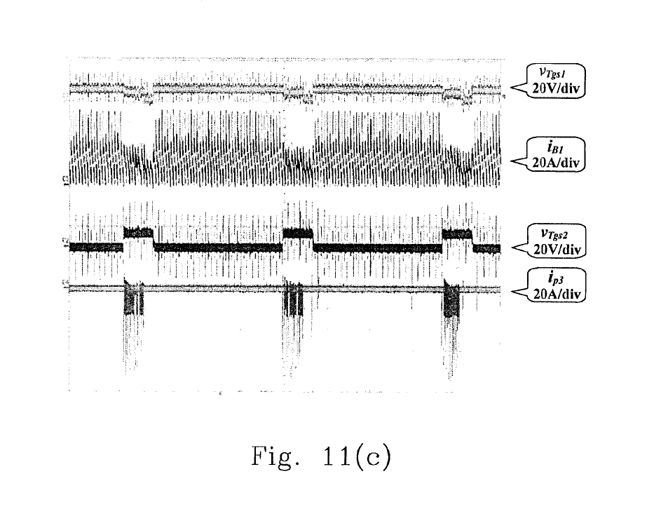

FIG. 11(a) shows measured gate drive signals V_{Tgs1} and V_{Tgs2} for Q_{T1} and Q_{T2} at a low frequency of 550 Hz, and V_{Fgs1}, V_{Fgs2} and V_{Fgs3} for Q_{F1}, Q_{F2}, and Q_{F3} at a high frequency of 19 kHz according to the preferred embodiment of the present invention. FIG. 11(b) shows the measured gate drive signals V_{Tgs1} and V_{Tgs2} for Q_{T1} and Q_{T2}, the charge current i_{B1} for B1 and the charge current i_{B2} for B2 according to the preferred embodiment of the present invention. FIG. 11(c) shows the measured gate drive signals V_{Tgs1} and V_{Tgs2} for Q_{T1} and Q_{T2}, and the burp charging currents i_{B1} and iₚ₃ according to the preferred embodiment of the present invention.

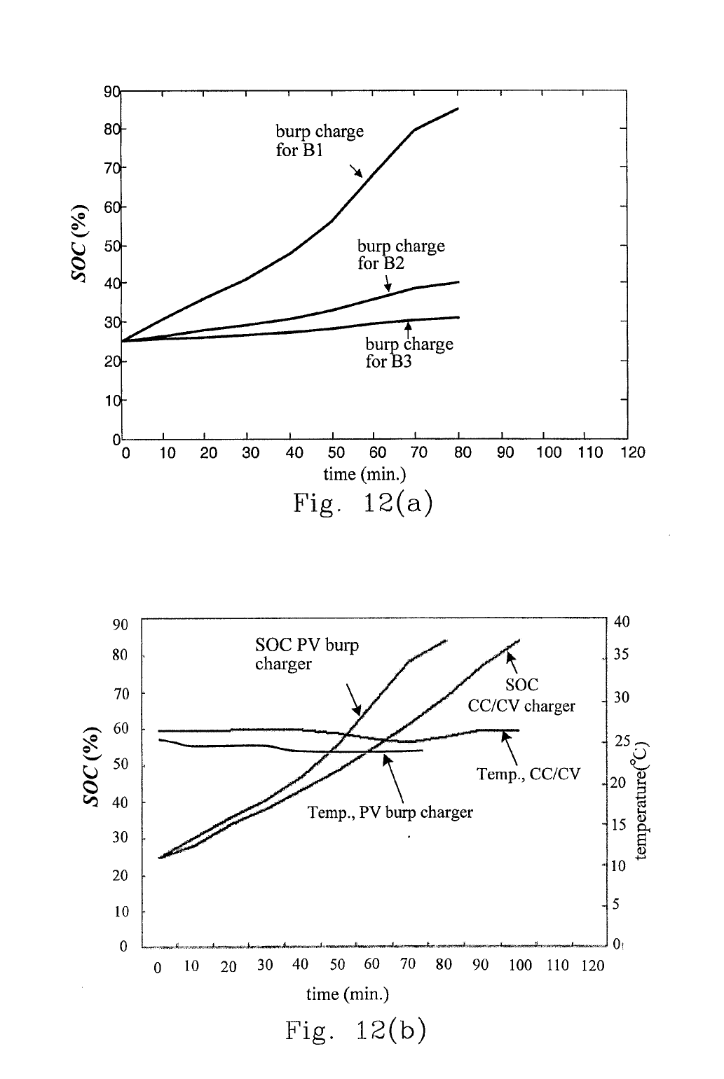

FIG. 12(a) shows trajectories of the proposed PV burp charger presenting the state-of-charge (SOC) of the three batteries in the process of PV burp charge, in which the charging process excluding the burp charge to B1 also contributes pulse charges to B2 and B3 in the non-burp charge period.

FIG. 12(b) compares the charging and temperature trajectories of the proposed PV burp charger with those obtained using the CC/CV charging strategy, at an average charging rate of 0.2 C, where 1 C=45AH, under solar insolation of 1 kW/m². To reach 85% SOC, it takes 85 minutes for burp charge and 105 minutes for CC/CV charge to the same battery, which clearly reveals shorter charging time of burp charge than that of CC/CV charge about 20%. Besides, there causes low heating for the B1 using burp charge in comparison to that using the CC/CV charge around 2° C., measured at environmental temperature of 20° C. The experiment successfully validates the performance of the PV system having the burp chargers that can provide rapid charging and low heating to the battery for benefiting the prolongation of the battery life.

### EMBODIMENTS

1. A photovoltaic system, comprising:

a first charger generating a first pulse train;

a first battery receiving the first pulse train at a first time period to engage in a first charge, and engaged in an intense discharge at an initial stage of a second time period so as to generate a second pulse train;

a second battery receiving the first pulse train during the second time period to engage in a second charge;

a third battery engaged in a third charge via the second pulse train during the initial stage; and

a charge management controller controlling the first charge and the intense discharge of the first battery, the second charge of the second battery and the third charge of the third battery.

2. A system according to Embodiment 1 further comprising a maximum power point tracking (MPPT) controller and a photovoltaic (PV) array, wherein the MPPT controller is electrically connected to the PV array to cause the PV array to engage in an MPPT, the PV array is electrically connected to the first charger, the first charger is an interleaved flyback converter and includes a first flyback converter and a second flyback converter, the first flyback converter is electrically connected to the second flyback converter in parallel, the first and the second flyback converters generate a third pulse train and a fourth pulse train respectively, and the third and the fourth pulse trains are synthesized to generate the first pulse train.

3. A system according to Embodiment 2 or 3 further comprising a first, a second and a third transmission switches and a second charger, wherein the second charger is electrically connected between the third battery and the third transmission switch, is used to receive the second pulse train and generates a charging pulse train charging the third battery, the first transmission switch is electrically connected between the first charger and the first battery, the second transmission switch is electrically connected between the first charger and the second battery, the third transmission switch is electrically connected to the first battery, and the charge management controller generates a first, a second, and a third control signals controlling a turn-on and a turn-off of the first to the third transmission switches respectively, and controlling when the first battery engages in the first charge and the intense discharge, when the second battery engages in the second charge, and when the third battery engages in the third charge.

4. A system according to anyone of the above-mentioned Embodiments, wherein the first, the second and the third batteries generate a first, a second and a third gassing voltage detection values respectively, the first, the second and the third transmission switches include respective gates, the charge management controller includes a transmission gate controller and a gassing voltage monitor, the transmission gate controller outputs the first, the second and the third control signals to the respective gates to control the turn-on and the turn-off of the first, the second and the third transmission switches, the gassing voltage monitor receives the first, the second and the third gassing voltage detection values and outputs respective enable signals to the transmission gate controller and the MPPT controller.

5. A system according to anyone of the above-mentioned embodiments, wherein the transmission gate controller engages in a normal operation and the MPPT controller engages in an MPPT when all the first, the second and the third gassing voltage detection values are not reaching a gassing voltage value, the transmission gate controller ceases the normal operation and the MPPT controller ceases the MPPT when at least one of the first, the second and the third gassing voltage detection values reaches the gassing voltage value, and the MPPT controller is an incremental-conductance (INC) MPPT controller.

6. A system according to anyone of the above-mentioned embodiments, further comprising a pulse-width modulation (PWM) controller, wherein the PWM controller uses a variable frequency constant duty control and outputs a PWM signal to the first charger, the first charger has a charging period including the first time period, the second time period and a brief break time period, and the first charge is a burp charge.

7. A photovoltaic system, comprising:

a first battery receiving a first pulse train at a first time period to engage in a first charge, and engaged in an intense discharge at an initial stage of a second time period so as to generate a second pulse train; and

a second battery engaged in a second charge via the second pulse train during the initial stage of the second time period.

8. A photovoltaic system according to Embodiment 7 further comprising:

a first charger generating the first pulse train;

a third battery receiving the first pulse train during the second time period to engage in a third charge; and

a charge management controller controlling the first charge and the intense discharge of the first battery, the second charge of the second battery and the third charge of the third battery.

9. A system according to Embodiment 7 or 8 further comprising a maximum power point tracking (MPPT) controller and a photovoltaic (PV) array, wherein the MPPT controller is electrically connected to the PV array to cause the PV array to engage in an MPPT, the PV array is electrically connected to the first charger, the first charger is an interleaved flyback converter and includes a first flyback converter and a second flyback converter, the first flyback converter is electrically connected to the second flyback converter in parallel, the first and the second flyback converters generate a third pulse train and a fourth pulse train respectively, and the third and the fourth pulse trains are synthesized to generate the first pulse train.

10. A system according to anyone of the above-mentioned embodiments, further comprising a first, a second and a third transmission switches and a second charger, wherein the second charger is electrically connected between the second battery and the second transmission switch, is used to receive the second pulse train and generates a charging pulse train charging the second battery, the first transmission switch is electrically connected between the first charger and the first battery, the third transmission switch is electrically connected between the first charger and the third battery, the second transmission switch is electrically connected to the first battery, and the charge management controller generates a first, a second, and a third control signals controlling a turn-on and a turn-off of the first to the third transmission switches, and controlling when the first battery engages in the first charge and the intense discharge, when the second battery engages in the second charge, and when the third battery engages in the third charge.

11. A system according to anyone of the above-mentioned embodiments, wherein the first, the second and the third batteries generate a first, a second and a third gassing voltage detection values respectively, the first, the second and the third transmission switches include respective gates, the charge management controller includes a transmission gate controller and a gassing voltage monitor, the transmission gate controller outputs the first, the second and the third control signals to the respective gates to control the turn-on and the turn-off of the first, the second and the third transmission switches, the gassing voltage monitor receives the first, the second and the third gassing voltage detection values and outputs respective enable signals to the transmission gate controller and the MPPT controller.

12. A system according to anyone of the above-mentioned embodiments, wherein the transmission gate controller engages in a normal operation and the MPPT controller engages in an MPPT when the first, the second and the third gassing voltage detection values are all not reaching a gassing voltage value, the transmission gate controller ceases the normal operation and the MPPT controller ceases the MPPT when at least one of the first, the second and the third gassing voltage detection values reaches the gassing voltage value, and the MPPT controller is an incremental-conductance (INC) MPPT controller.

13. A system according to anyone of the above-mentioned embodiments, further comprising a pulse-width modulation (PWM) controller, wherein the PWM controller uses a variable frequency constant duty control and outputs a PWM signal to the first charger, the first charger has a charging period including the first time period, the second time period and a brief break time period, and the first charge is a burp charge.

14. A charging method for a photovoltaic system, comprising steps of:

providing a first pulse train;

receiving the first pulse train at a first time period to engage in a first charge towards a first battery; and

causing the first battery to engage in an intense discharge at an initial stage of a second time period to generate a second pulse train so as to engage in a second charge towards a second battery.

15. A method according to Embodiment 14, further comprising steps of:

providing a third battery and a first charger generating the first pulse train; and

causing the third battery to engage in a third charge via the second pulse train during the initial stage of the second time period.

16. A method according to Embodiment 14 or 15, wherein the photovoltaic system comprises a controller and a second charger, the method further comprising steps of:

controlling the first charge and the intense discharge of the first battery, the second charge of the second battery and the third charge of the third battery; and

causing the second charger to receive the second pulse train and to output a third pulse train so as to charge the third battery.

According to the aforementioned descriptions, the present invention provides a photovoltaic burp charger and charging method thereof, the photovoltaic burp charger includes a charge management controller used to engage in a photovoltaic burp charge and two pulse charges in a main battery and two auxiliary batteries respectively so as to prolong the life-cycle of the battery and realizing the concept of energy treasuring and recovery so as to possess the non-obviousness and the novelty.

While the present invention has been described in terms of what are presently considered to be the most practical and preferred embodiments, it is to be understood that the present invention need not be restricted to the disclosed embodiments. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A photovoltaic system, comprising:
a first charger generating a first pulse train;
a first battery receiving the first pulse train at a first time period to engage in a first charge, and engaged in an intense discharge at an initial stage of a second time period so as to generate a second pulse train;
a second battery receiving the first pulse train during the second time period to engage in a second charge;
a third battery engaged in a third charge via the second pulse train during the initial stage; and
a charge management controller controlling the first charge and the intense discharge of the first battery, the second charge of the second battery and the third charge of the third battery.

2. A system according to claim 1 further comprising a maximum power point tracking (MPPT) controller and a photovoltaic (PV) array, wherein the MPPT controller is electrically connected to the PV array to cause the PV array to engage in an MPPT, the PV array is electrically connected to the first charger, the first charger is an interleaved flyback converter and includes a first flyback converter and a second flyback converter, the first flyback converter is electrically connected to the second flyback converter in parallel, the first and the second flyback converters generate a third pulse train and a fourth pulse train respectively, and the third and the fourth pulse trains are synthesized to generate the first pulse train.

3. A system according to claim 2 further comprising a first, a second and a third transmission switches and a second charger, wherein the second charger is electrically connected between the third battery and the third transmission switch, is used to receive the second pulse train and generates a charging pulse train charging the third battery, the first transmission switch is electrically connected between the first charger and the first battery, the second transmission switch is electrically connected between the first charger and the second battery, the third transmission switch is electrically connected to the first battery, and the charge management controller generates a first, a second, and a third control signals controlling a turn-on and a turn-off of the first to the third transmission switches respectively, and controlling when the first battery engages in the first charge and the intense discharge, when the second battery engages in the second charge, and when the third battery engages in the third charge.

4. A system according to claim 3, wherein the first, the second and the third batteries generate a first, a second and a third gassing voltage detection values respectively, the first, the second and the third transmission switches include respective gates, the charge management controller includes a transmission gate controller and a gassing voltage monitor, the transmission gate controller outputs the first, the second and the third control signals to the respective gates to control the turn-on and the turn-off of the first, the second and the third transmission switches, the gassing voltage monitor receives the first, the second and the third gassing voltage detection values and outputs respective enable signals to the transmission gate controller and the MPPT controller.

5. A system according to claim 4, wherein the transmission gate controller engages in a normal operation and the MPPT controller engages in an MPPT when all the first, the second and the third gassing voltage detection values are not reaching a gassing voltage value, the transmission gate controller ceases the normal operation and the MPPT controller ceases the MPPT when at least one of the first, the second and the third gassing voltage detection values reaches the gassing voltage value, and the MPPT controller is an incremental-conductance (INC) MPPT controller.

6. A system according to claim 1 further comprising a pulse-width modulation (PWM) controller, wherein the PWM controller uses a variable frequency constant duty control and outputs a PWM signal to the first charger, the first charger has a charging period including the first time period, the second time period and a brief break time period, and the first charge is a burp charge.

7. A photovoltaic system, comprising:
a first battery receiving a first pulse train at a first time period to engage in a first charge, and engaged in an intense discharge at an initial stage of a second time period so as to generate a second pulse train; and
a second battery engaged in a second charge via the second pulse train during the initial stage of the second time period.

8. A photovoltaic system according to claim 7 further comprising:
a first charger generating the first pulse train;
a third battery receiving the first pulse train during the second time period to engage in a third charge; and
a charge management controller controlling the first charge and the intense discharge of the first battery, the second charge of the second battery and the third charge of the third battery.

9. A system according to claim 8 further comprising a maximum power point tracking (MPPT) controller and a photovoltaic (PV) array, wherein the MPPT controller is electrically connected to the PV array to cause the PV array to engage in an MPPT, the PV array is electrically connected to the first charger, the first charger is an interleaved flyback converter and includes a first flyback converter and a second flyback converter, the first flyback converter is electrically connected to the second flyback converter in parallel, the first and the second flyback converters generate a third pulse train and a fourth pulse train respectively, and the third and the fourth pulse trains are synthesized to generate the first pulse train.

10. A system according to claim 9 further comprising a first, a second and a third transmission switches and a second charger, wherein the second charger is electrically connected between the second battery and the second transmission switch, is used to receive the second pulse train and generates a charging pulse train charging the second battery, the first transmission switch is electrically connected between the first charger and the first battery, the third transmission switch is electrically connected between the first charger and the third battery, the second transmission switch is electrically connected to the first battery, and the charge management controller generates a first, a second, and a third control signals controlling a turn-on and a turn-off of the first to the third transmission switches, and controlling when the first battery engages in the first charge and the intense discharge, when the second battery engages in the second charge, and when the third battery engages in the third charge.

11. A system according to claim 10, wherein the first, the second and the third batteries generate a first, a second and a third gassing voltage detection values respectively, the first, the second and the third transmission switches include respective gates, the charge management controller includes a transmission gate controller and a gassing voltage monitor, the transmission gate controller outputs the first, the second and the third control signals to the respective gates to control the turn-on and the turn-off of the first, the second and the third transmission switches, the gassing voltage monitor receives the first, the second and the third gassing voltage detection values and outputs respective enable signals to the transmission gate controller and the MPPT controller.

12. A system according to claim 11, wherein the transmission gate controller engages in a normal operation and the MPPT controller engages in an MPPT when the first, the second and the third gassing voltage detection values are all not reaching a gassing voltage value, the transmission gate controller ceases the normal operation and the MPPT controller ceases the MPPT when at least one of the first, the second and the third gassing voltage detection values reaches the gassing voltage value, and the MPPT controller is an incremental-conductance (INC) MPPT controller.

13. A system according to claim 7 further comprising a pulse-width modulation (PWM) controller, wherein the PWM controller uses a variable frequency constant duty control and outputs a PWM signal to the first charger, the first charger has a charging period including the first time period, the second time period and a brief break time period, and the first charge is a burp charge.

14. A charging method for a photovoltaic system, comprising steps of:
providing a first pulse train;
receiving the first pulse train at a first time period to engage in a first charge towards a first battery; and
causing the first battery to engage in an intense discharge at an initial stage of a second time period to generate a second pulse train so as to engage in a second charge towards a second battery.

15. A method according to claim 14, further comprising steps of:
providing a third battery and a first charger generating the first pulse train; and
causing the third battery to engage in a third charge via the second pulse train during the initial stage of the second time period.

16. A method according to claim 15, wherein the photovoltaic system comprises a controller and a second charger, the method further comprising steps of:
controlling the first charge and the intense discharge of the first battery, the second charge of the second battery and the third charge of the third battery; and
causing the second charger to receive the second pulse train and to output a third pulse train so as to charge the third battery.
